(19) United States
(12) Patent Application Publication
(10) Pub. No.: US 2025/0165143 A1
(43) Pub. Date: May 22, 2025

(54) SYSTEM AND METHOD FOR REDUCING MEMORY FOOTPRINT FOR DATA STORED IN A COMPRESSED MEMORY SUBSYSTEM

(71) Applicant: QUALCOMM Incorporated, San Diego, CA (US)

(72) Inventors: Kan WANG, San Diego, CA (US); Norris GENG, San Diego, CA (US); Richard SENIOR, San Diego, CA (US); Christopher KOOB, Round Rock, TX (US); Pranav VERMA, Bangalore (IN); Suresh Kumar VENKUMAHANTI, Austin, TX (US); Gurvinder Singh CHHABRA, San Diego, CA (US)

(21) Appl. No.: 18/513,393

(22) Filed: Nov. 17, 2023

(51) Int. Cl. G06F 3/06

(52) U.S. Cl. CPC G06F 3/0608; G06F 3/0638; G06F 3/0673

(57) ABSTRACT

A method for reducing a memory footprint of data stored in a compressed memory subsystem is described. The method includes selecting a read/write data to store in the compressed memory subsystem. The method also includes searching a first compressed data storage pool of the compressed memory subsystem corresponding to a compressed size of the read/write data to identify a first free data block. The method further includes storing the read/write data in a second free data block from a second compressed data storage pool of the compressed memory subsystem corresponding to a compressed size of the read/write data if the first compressed data storage pool is exhausted.

### BACKGROUND

### Field

Aspects of the present disclosure relate to memory subsystems and, more particularly, to a system and method for reducing memory footprint for data stored in a compressed memory subsystem.

### Background

Memory is a vital component for wireless communications devices. For example, a cell phone may integrate memory as part of an application processor, such as a system-on-chip (SoC) including a central processing unit (CPU) and a graphics processing unit (GPU). Successful operation of some wireless applications depends on the availability of high-capacity and low-latency memory solutions for scalability of CPU/GPU workload. Cache memory is a chip-based computer component that operates as a temporary storage area for expediting data retrieval by the CPU/GPU. In particular, the cache memory is typically integrated directly into the CPU/GPU chip or placed on a separate chip that has a separate bus interconnect with the CPU/GPU.

Unfortunately, this physical proximity to the CPU/GPU limits the size of the cache memory relative to the main memory, which leads to less storage space. Additionally, cache memory is more expensive than main memory due to chip complexity for achieving higher performance. In practice, double data rate (DDR) dynamic random-access memory (DRAM) is commonly used to implement cache memory, such as a last-level cache (LLC). Data compression, which is defined as a process for reducing the size of stored data files, may expand the storage available from cache memory. Unfortunately, data compression is subject to significant design trade-offs. A system and method for reducing a memory footprint for data stored in a compressed memory subsystem is desired.

### SUMMARY

A method for reducing a memory footprint of data stored in a compressed memory subsystem is described. The method includes selecting a read/write data to store in the compressed memory subsystem. The method also includes searching a first compressed data storage pool of the compressed memory subsystem corresponding to a compressed size of the read/write data to identify a first free data block. The method further includes storing the read/write data in a second free data block from a second compressed data storage pool of the compressed memory subsystem corresponding to a compressed size of the read/write data if the first compressed data storage pool is exhausted.

A non-transitory computer-readable medium having program code recorded thereon for reducing a memory footprint of data stored in a compressed memory subsystem is described. The program code is executed by a processor. The non-transitory computer-readable medium includes program code to select a read/write data to store in the compressed memory subsystem. The non-transitory computer-readable medium also includes program code to search a first compressed data storage pool of the compressed memory subsystem corresponding to a compressed size of the read/write data to identify a first free data block. The non-transitory computer-readable medium further includes program code to store the read/write data in a second free data block from a second compressed data storage pool of the compressed memory subsystem corresponding to a compressed size of the read/write data if the first compressed data storage pool is exhausted.

This has outlined, broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-chip (SoC), which is configured for memory footprint reduction of data stored in a compressed memory subsystem, in accordance with various aspects of the present disclosure.

FIG. 2 is a circuit diagram further illustrating the system-on-chip (SoC) of FIG. 1, including a compressed memory system in which a memory footprint of stored data is reduced, according to various aspects of the present disclosure.

FIG. 3 is a block diagram further illustrating the compressed data block pools of the compressed memory subsystem of FIG. 2, according to various aspects of the present disclosure.

FIG. 4 is a block diagram further illustrating the compressed data block pools of the compressed memory subsystem of FIG. 2, according to various aspects of the present disclosure.

FIG. 5 is a block diagram further illustrating the compressed data block pools of the compressed memory subsystem of FIG. 2, according to various aspects of the present disclosure.

FIG. 6 is a process flow diagram illustrating a method for reducing a memory footprint of data stored in a compressed memory subsystem, according to various aspects of the present disclosure.

FIG. 7 is a block diagram showing an exemplary wireless communications system in which a configuration of the disclosure may be advantageously employed.

FIG. 8 is a block diagram illustrating a design workstation used for circuit, layout, and logic design of a semiconductor component according to one configuration.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form to avoid obscuring such concepts.

As described herein, the use of the term “and/or” is intended to represent an “inclusive OR,” and the use of the term “or” is intended to represent an “exclusive OR.” As described herein, the term “exemplary” used throughout this description means “serving as an example, instance, or illustration,” and should not necessarily be construed as preferred or advantageous over other exemplary configurations. As described herein, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described herein, the term “proximate” used throughout this description means “adjacent, very near, next to, or close to.” As described herein, the term “on” used throughout this description means “directly on” in some configurations, and “indirectly on” in other configurations. It will be understood that the term “layer” includes film and is not construed as indicating a vertical or horizontal thickness unless otherwise stated. As described, the term “substrate” may refer to a substrate of a diced wafer or may refer to a substrate of a wafer that is not diced. Similarly, the terms “chip” and “die” may be used interchangeably.

Memory is a vital component for wireless communications devices. For example, a cell phone may integrate memory as part of an application processor, such as a system-on-chip (SoC) including a central processing unit (CPU) and a graphics processing unit (GPU). Successful operation of some wireless applications depends on the availability of higher-capacity and low-latency memory solutions for scalability of CPU/GPU workload. Cache memory is a chip-based computer component that operates as a temporary storage area for expediting data retrieval by the CPU/GPU. In particular, the cache memory is typically integrated directly into the CPU/GPU chip or placed on a separate chip that has a separate bus interconnect with the CPU/GPU.

Unfortunately, this physical proximity to the CPU/GPU limits the size of the cache memory relative to the main memory, which leads to less storage space. Additionally, cache memory is more expensive than main memory due to chip complexity for achieving higher performance. In practice, double data rate (DDR) dynamic random-access memory (DRAM) is commonly used to implement cache memory, such as a last-level cache (LLC). Data compression, which is defined as a process for reducing the size of stored data files, may expand the storage available from cache memory. Unfortunately, data compression is subject to significant design trade-offs. A system and method for reducing a memory footprint for data stored in a compressed memory subsystem, is desired.

Various aspects of the present disclosure are directed to a system and method for reducing a memory footprint of data stored in a compressed memory subsystem. The method includes selecting read/write data to store in the compressed memory subsystem. In response to the read/write data, a search is performed in a first data block pool of the compressed memory subsystem corresponding to a compressed size of the read/write data to identify a first free data block. If the first data block pool is exhausted, the read/write data is stored in a second free data block from a second data block pool of the compressed memory subsystem corresponding to an uncompressed size of the read/write data. Otherwise, compressed read/write data is stored in the first free data block from the first data block pool of the compressed memory subsystem.

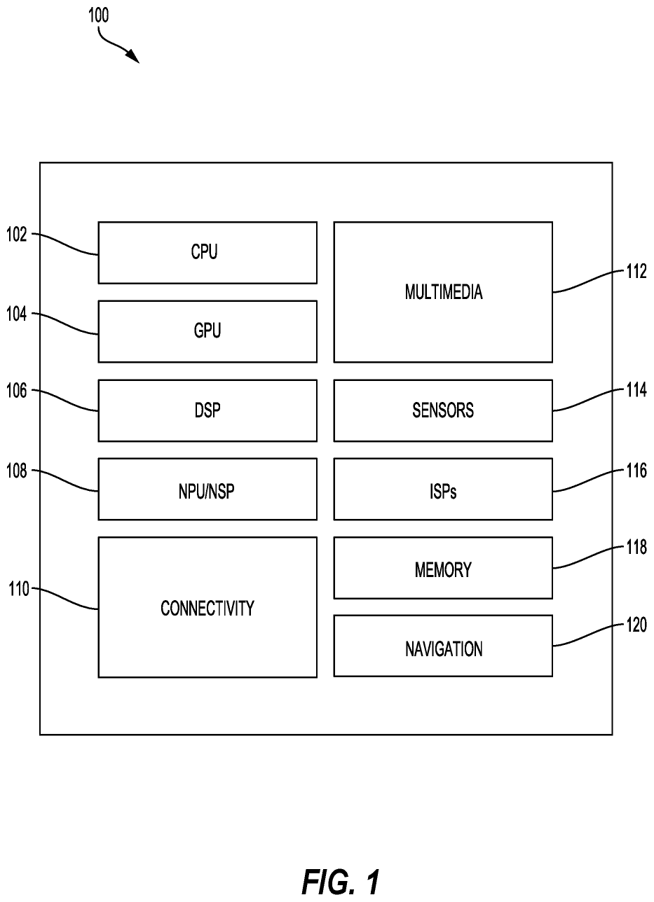

FIG. 1 illustrates an example implementation of a host system-on-chip (SoC) 100, which is configured for memory footprint reduction of data stored in a compressed memory subsystem, in accordance with various aspects of the present disclosure. The host SoC 100 includes processing blocks tailored to specific functions, such as a connectivity block 110. The connectivity block 110 may include sixth generation (6G), connectivity fifth generation (5G) new radio (NR) connectivity, fourth generation long term evolution (4G LTE) connectivity, Wi-Fi connectivity, USB connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU)/neural signal processor (NSP) 108. The host SoC 100 may also include a sensor processor 114, image signal processors (ISPs) 116, a navigation module 120, which may include a global positioning system, and a memory 118. The multi-core CPU 102, the GPU 104, the DSP 106, the NPU/NSP 108, and the multimedia engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU/NSP 108 may be based on an ARM instruction set.

Data compression is defined as a process for reducing the size of a data file. Data compression beneficially reduces the resources specified to store data; however, computational resources are consumed in the compression and decompression processes. As a result, data compression is subject to significant design trade-offs. In particular, the design of data compression schemes involves trade-offs among several factors, including the degree of compression, the amount of distortion introduced (when using lossy data compression), and the computational resources specified to compress and decompress the data. Data compressing may decrease the amount of double data rate (DDR) memory used to hold read/write data.

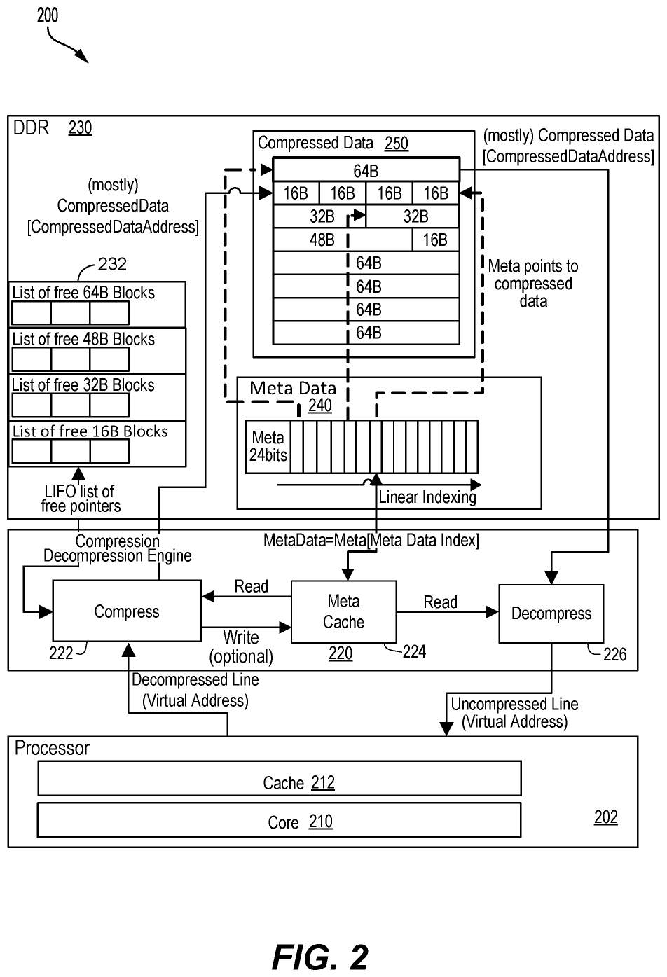

FIG. 2 is a circuit diagram further illustrating the system-on-chip (SoC) of FIG. 1, including a compressed memory system in which a memory footprint of stored data is reduced, according to various aspects of the present disclosure. As shown in FIG. 2, a processor 202 (e.g., the CPU 102 of FIG. 1) includes processor cores 210 as well as a cache 212, including a set of cache lines. In various aspects of the present disclosure, cache lines from the cache 212 are processed by a compression/decompression engine 220 for storage in a memory 230 of a compressed memory subsystem 200 as compressed data in a compressed data storage 250. The compressed data storage 250 supports dynamic utilization of compressed data block pools during runtime depending on the compressibility of a data pattern. The compressed data is compressed using a compression engine 222 and decompressed using a decompression engine 226 based on data in a meta cache 224.

In various aspects of the present disclosure, meta data 240 provides a mapping from a data address to a location of the compressed data in the compressed data storage 250. Similarly, decompression involves a lookup into the meta data 240, which supplies the location of a compressed data block in the compressed data storage 250. In operation, compression involves analyzing the previous meta data to determine whether a compressed data block is reusable. If a compressed data block is not reusable, the compressed data block is recycled to the appropriate free list 232 and a new compressed data block of the appropriate size is allocated to the compressed data storage 250.

Various aspects of the present disclosure facilitate the compressed data block borrowing schemes by employing garbage collection mechanisms. For example, when reading a cache line from the cache 212 through the compression/decompression engine 220, the meta cache 224 is checked to see if it is borrowed. Then, a recompression can be triggered by: (1) marking the cache line dirty in a level two (L2) cache; and (2) setting the cache line in the memory 230 (e.g., DDR memory) to zeros for early return of the borrowed block. For example, a hardware engine, such as the compression/decompression engine 220 can keep a counter for borrowing events and if the number reaches a threshold, trigger a scan of meta data to find the borrowed entries.

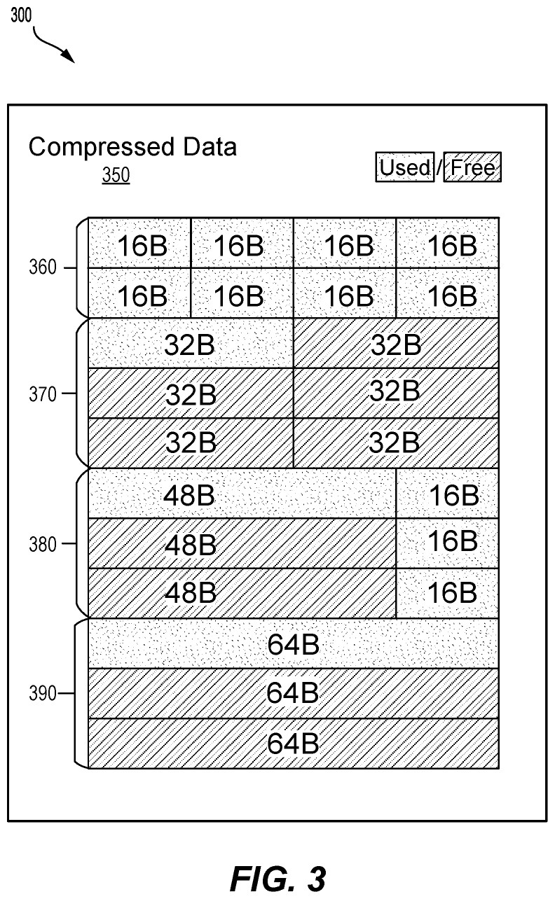

FIG. 3 is a block diagram further illustrating the compressed data block pools of the compressed memory subsystem of FIG. 2, according to various aspects of the present disclosure. As shown in FIG. 3, a compressed data storage 350 of a compressed memory subsystem 300 supports dynamic utilization of compressed data block pools during runtime depending on the compressibility of a data pattern. In this example, a first compressed data block pool 360 supports sixteen (16) byte (16B) blocks, and a second compressed data block pool 370 supports thirty-two (32) byte (32B) blocks. Additionally, a third compressed data block pool 380 supports a combination of forty-eight (48) byte (48B) blocks and 16B blocks, while a fourth compressed data block pool 390 supports a combination of sixty-four (64) byte (64B) blocks.

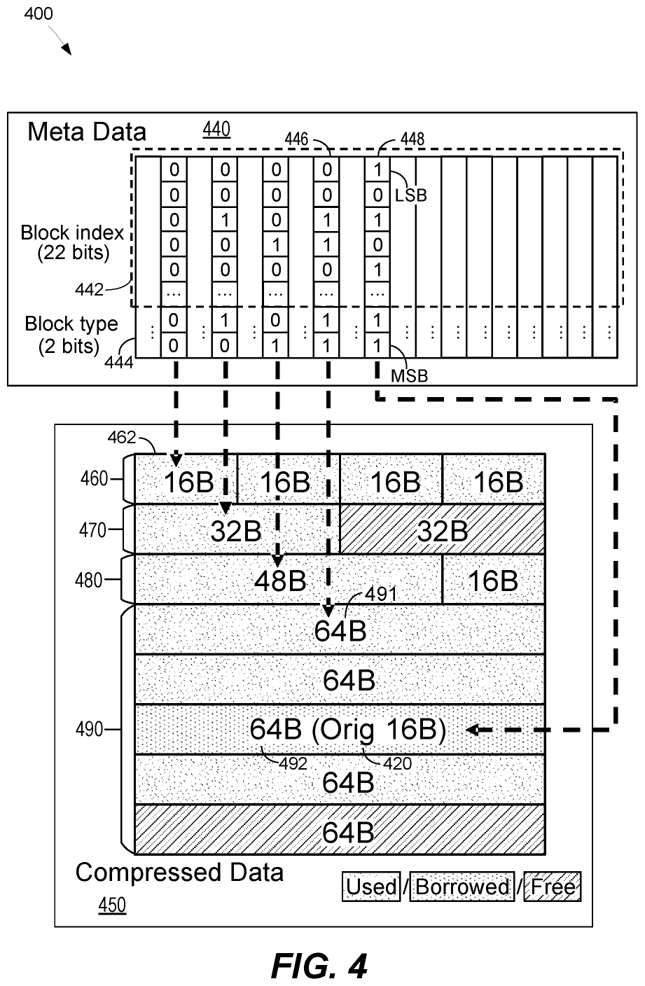

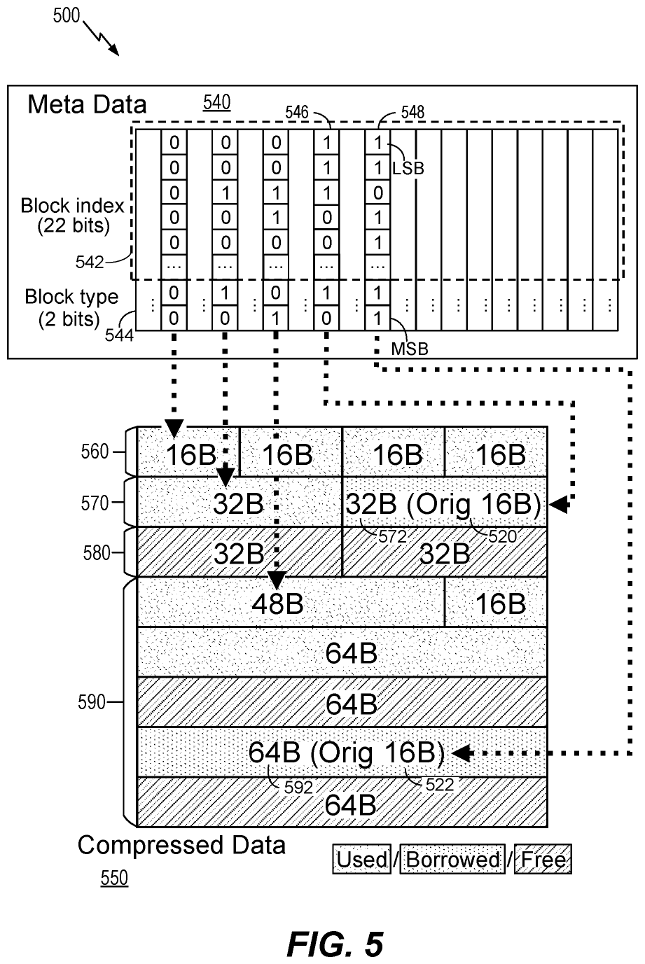

Unfortunately, if a compressed data block pool of the compressed data storage 350 is exhausted, the compressed memory subsystem 300 may fail to recover and may crash. In this example, the first compressed data block pool 360 is exhausted because each of the 16B blocks are being used. As a result, receipt of another compressed 16B block may lead to a failed recovery and crash because the first compressed data block pool 360 is exhausted while the second, third, and fourth compressed data block pools (e.g., 370-390) are still at low usage. Various aspects of the present disclosure provide a memory footprint reduction of data stored in the compressed memory subsystem 300, such that each of the compressed data block pools (e.g., 360-390) have sufficient size for maximum utilization. These aspects of the present disclosure increase overall compressed data block usage by eliminating unused data blocks, for example, as shown in FIGS. 4 and 5.

FIG. 4 is a block diagram further illustrating the compressed data block pools of the compressed memory subsystem of FIG. 2, according to various aspects of the present disclosure. As shown in FIG. 4, a compressed memory subsystem 400 including meta data 440 and a compressed data storage 450, having a first compressed data storage pool 460, a second compressed data storage pool 470, a third compressed data storage pool 480, and a fourth compressed data storage pool 490. In this example, a largest (e.g., 64B) data block of the compressed data block pools is the same size as a cache line from the cache 212, as shown in FIG. 2.

For example, as shown in FIG. 2, when a cache line of data from the cache 212 cannot be compressed to fit into smaller compressed blocks, it is stored as uncompressed data in a largest compressed data block. As shown in FIG. 4, the first compressed data storage pool 460 of the compressed data storage 450 corresponding to the 16B data blocks is exhausted because a free 16B data block is unavailable. Rather than generating an interrupt and crashing because the first compressed data storage pool 460 is exhausted, an unused block 492 from the largest compressed data storage pool (e.g., the fourth compressed data storage pool 490) is borrowed to store the uncompressed data 420. This process is summarized in Table I.

TABLE I
Compressed/Uncompressed Data Storage

| | Uncompressed | Data stored as | Meta data Type | Meta data index |
|---|---|---|---|---|
| Solution | Data Size | compressed/uncompressed | bits | bits |
| 1 - Borrow | 64B (size of | Uncompressed | Will indicate the | Will use the 2 |
| from | one cache | (because Largest | pool being | LSBs to encode |
| Largest | line) | Block size = 64B = | borrowed (11 | original pool |
| Block Pool | | uncompressed | for 64B) | |
| | | cache line size) | | |
| 2 - Borrow | 64B (size of | Compressed | Will indicate the | Will use the 1 |
| from Next | one cache | (because next available | pool being | (for 32B) or 2 |
| Available | line) | block size likely < | borrowed (could | (for 48B and |
| Block Pool | | uncompressed cache line | be 01, 10, or 11) | 64B) LSBs to |
| | | size) | | encode original |
| | | | | pool |

According to various aspects of the present disclosure, the meta data 440 is encoded to support borrowing of data blocks from the compressed data block pools. In this example, the meta data 440 includes a block index field 442 to indicate if a free data block is borrowed. Additionally, the most significant two bits of a block type field 444 of the meta data 440 identify the block type (e.g., ‘00’—16B, ‘01’—32B, ‘10’—48, and ‘11’—64B) using the two most significant bits (MSBs). For example, the compressed data storage 450 is divided into 16B blocks and indexed using the block index field 442. For 64B blocks from the fourth compressed data storage pool 490 that are not borrowed, the meta block index is four (4) aligned (each 64B block contains four 16B blocks), making the two least significant bits (LSBs) equal to zero (0).

As shown in FIG. 4, the meta data 440 is illustrated based on the assumption that a first 16B block 462 is at index 0 and the index number for the blocks grow from left to right and top to bottom. In this example, setting the two LSBs of the block index field 442 to 01, 10, or 11 indicates the 64B block was borrowed by the 16B, 32B, or 48B block pools, respectively. This allows smaller compressed block pools to be configured tightly, saving the memory footprint of the compressed memory subsystem 400, while the fourth compressed data storage pool 490 is over-provisioned to cover spike usages of the other compressed block pools (e.g., 460-480).

For example, a meta data entry 446 pointing to a 64B block 491 is regular meta data. As a result, the block index field 442 of the meta data entry 446 equals 12 in binary (e.g., 01100b). Similarly, if a meta data entry 448 pointing to the unused block 492 was regular meta data, the block index field 442 of the meta data entry 448 would equal 20 in binary (e.g., 10100b). In this example, however, the unused block 492 is borrowed by the uncompressed data 420 (e.g., original 16B block). Consequently, the block index field 442 of the meta data entry 448 equals 21 in binary (e.g., 10101b). Alternatively, if the unused block 492 was borrowed by a 32B block, the block index field 442 of the meta data entry 448 would equal 22 in binary (e.g., 10110b). Additionally, if the unused block 492 is borrowed by a 48B block, the block index field 442 of the meta data entry 448 equals 22 in binary (e.g., 10111b).

FIG. 5 is a block diagram further illustrating the compressed data block pools of the compressed memory subsystem of FIG. 2, according to various aspects of the present disclosure. As shown in FIG. 5, a compressed memory subsystem 500 also includes meta data 540 and a compressed data storage 550, having a first compressed data storage pool 560, a second compressed data storage pool 570, a third compressed data storage pool 580, and a fourth compressed data storage pool 590. As shown in FIG. 5, the first compressed data storage pool 560 of the compressed data storage 550 corresponding to the 16B data blocks is exhausted because a free 16B data block is unavailable. Rather than generating an interrupt and crashing because the first compressed data storage pool 560 is exhausted, an unused block 572 from the next larger compressed data block pool (e.g., the second compressed data storage pool 570) is borrowed to store the compressed data 520. Similarly, because the third compressed data storage pool 580 is exhausted, an unused block 592 from the next larger compressed data block pool (e.g., the fourth compressed data storage pool 590) is borrowed to store the compressed data 522.

As shown in FIG. 5, when a smaller compressed data block pool (e.g., the first compressed data storage pool 560) is exhausted, instead of generating an interrupt and crash, an unused block 572 from the second compressed data storage pool 570 (e.g., the next available larger data storage pool) is borrowed to store the compressed data 520, according to various aspects of the present disclosure. According to various aspects of the present disclosure, the meta data 540 is encoded to support borrowing of data blocks from the compressed data block pools (e.g., 570-590). In this example, the meta data 540 includes a block index field 542 to indicate if a compressed block is borrowed. For example, the meta data 540 for a cache line uses one or two of the least significant bits (LSBs) in the block index field 542 to indicate if a compressed block is borrowed. Additionally, the most significant two bits of a block type field 544 of the meta data 540 identify the block type (e.g., ‘00’—16B, ‘01’—32B, ‘10’—48, and ‘11’—64B).

In this example, the compressed data storage 550 is also divided into 16B blocks and indexed. For 32B blocks that are not borrowed, the block index field 542 is two (2) aligned (e.g., each 32B block contains two 16B blocks), making the LSB equal to zero (0). Setting the LSB to one (1) indicates the 32B block was borrowed by a 16B block. For 48B/64B blocks that are not borrowed, the block index field 542 is four (4) aligned (e.g., each 64B block contains four 16B blocks), making the two LSBs of the block index field 542 equal to zero (0). Setting the two LSBs of the block index field 542 to 01, 10, or 11 indicates the 48B/64B block was borrowed by the 16B, 32B, or 48B block pools, respectively.

For example, if a meta data entry 546 pointing to the unused block 572 is regular meta data, the block index field 542 of the meta data entry 546 would be 6 in binary (e.g., 00110b). In this example, however, the unused block 572 is borrowed by the compressed data 520 (e.g., original 16B block). Consequently, the block index field 542 of the meta data entry 546 equals 7 in binary (e.g., 00111b). Similarly, if the meta data entry 548 pointing the unused block 592 was regular meta data, the block index field 542 of the meta data entry 548 would equal 24 in binary (e.g., 11000b). In this example, however, the unused block 592 is borrowed by the compressed data 522 (e.g., original 48B block). Consequently, the block index field 542 of the meta data entry 546 equals 27 in binary (e.g., 11011b). Alternatively, if the unused block 592 was borrowed by the compressed data 520 (e.g., original 16B block), the block index field 542 of the meta data entry 548 would equal 25 in binary (e.g., 11001b). Additionally, if the unused block 592 was borrowed by a 32B block, the block index field 542 of the meta data entry 548 would equal 26 in binary (e.g., 11010b).

In various aspects of the present disclosure, the smaller compressed data block pools (e.g., 560 and 570) are tightly configured, which reduces a memory footprint of the compressed memory subsystem 500, while the larger compressed data block pools (e.g., 580 and 590) are over-provisioned to tightly cover spike usages of the smaller compressed data block pools (e.g., 560 and 570). This reduction of the memory footprint enables a smaller physical memory or the introduction of additional features in the existing memory. Additionally, repurposing unused compressed data blocks reduces the memory overhead associated with compressed data of a compressed memory subsystem.

Various aspects of the present disclosure are directed to a method for encoding up-binning (e.g., borrowing) in the meta data. For example, encoding of up-binning in the meta data is performed based on a dependence on the larger bins having memory alignment assumptions and violating this assumption to encode the degree of up-binning. For example, the 16B block bins have a 16-byte alignment. This is the smallest bin size, so the address bits [3:0] are not part of the meta data. By contrast, 64B block bins have a 64-byte alignment. As a result, the address bits [5:4] are included in the meta data but are equal to zero. The meta data also includes the size of the bin.

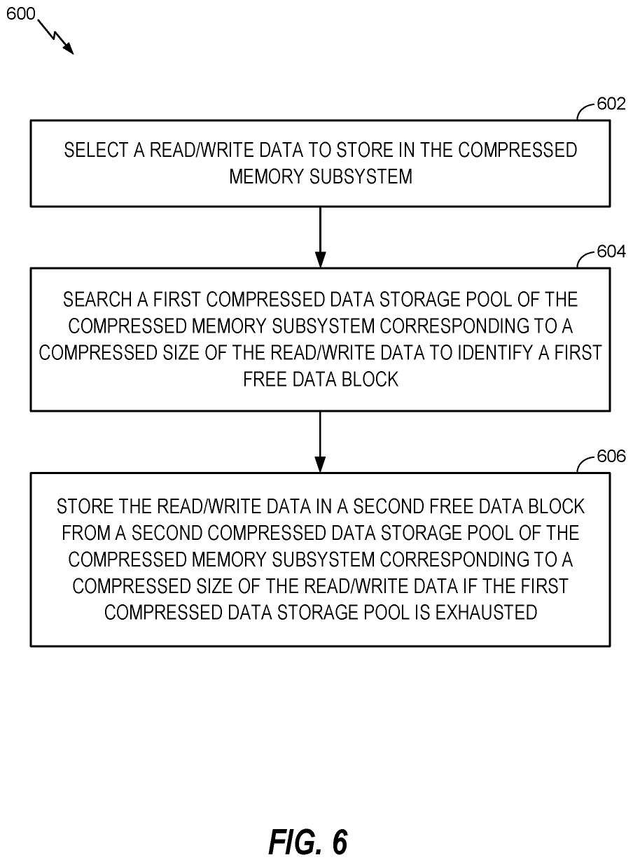

In these aspects of the present disclosure, using the size of the bin enables use of the last two address bits of the meta data (and one bit for 32B block bins) to encode up-binning. Specifically, if the bin size and address do not agree, the bin was used for up-binning. The address bits (or bit for the 32B block bins) can be used to determine the size of the compressed data stored in the larger bin. This encoding scheme provides two competitive advantages. First, up-binning can be determined by examining the meta data. Limiting examining to the meta data is significantly more efficient than having to fetch and decode the data. Additionally, because the compressed data size can be determined from the meta data, this allows for a more efficient read of compressed data, thus saving memory bandwidth and power. A process for reducing a memory footprint of data stored in a compressed memory subsystem is shown, for example, in FIG. 6.

FIG. 6 is a process flow diagram illustrating a method for reducing a memory footprint of data stored in a compressed memory subsystem, according to various aspects of the present disclosure. A method 600 begins at block 602, in which a read/write data is selected to store in the compressed memory subsystem. For example, as shown in FIG. 2, cache lines from the cache 212 are processed by a compression/decompression engine 220 for storage in a memory 230 of a compressed memory subsystem 200 as compressed data in a compressed data storage 250. The compressed data storage 250 supports dynamic utilization of compressed data block pools during runtime depending on the compressibility of a data pattern. The compressed data is compressed using a compression engine 222 and decompressed using a decompression engine 226 based on data in a meta cache 224.

At block 604, a first compressed data storage pool of the compressed memory subsystem corresponding to a compressed size of the read/write data is searched to identify a first free data block. For example, as shown in FIG. 4, the first compressed data storage pool 460 of the compressed data storage 450 corresponding to the 16B data blocks is exhausted because a free 16B data block is unavailable. Rather than generating an interrupt and crashing because the first compressed data storage pool 460 is exhausted, an unused block 492 from the largest compressed data storage pool (e.g., the fourth compressed data storage pool 490) is borrowed to store the compressed data 420.

At block 606, the read/write data is store in a second free data block from a second compressed data storage pool of the compressed memory subsystem corresponding to a compressed size of the read/write data if the first compressed data storage pool is exhausted. For example, as shown in FIG. 5, when a smaller compressed data block pool (e.g., the first compressed data storage pool 560) is exhausted, instead of generating an interrupt and crash, an unused block 572 from the second compressed data storage pool 570 (e.g., the next available larger data storage pool) is borrowed to store the compressed data 520, according to various aspects of the present disclosure.

In some aspects, the method 600 may be performed by the SoC 100 (FIG. 1). That is, each of the elements of method 600 may, for example, but without limitation, be performed by the SoC 100 or one or more processors (e.g., CPU 102 and/or NPU 130) and/or other components included therein.

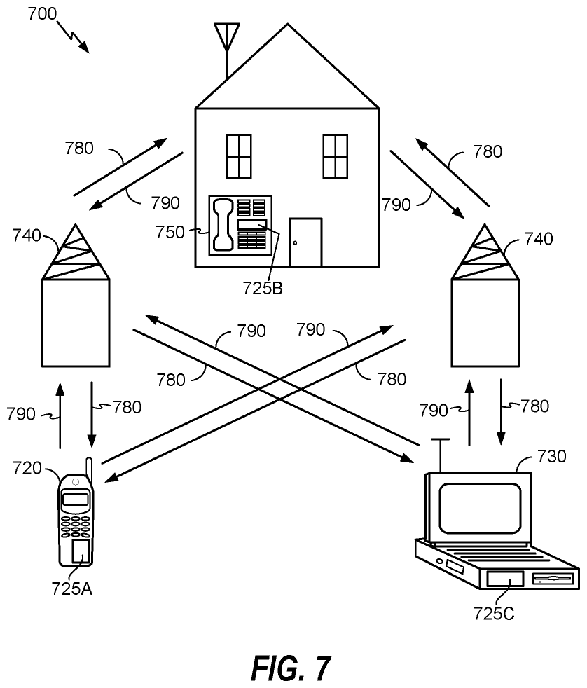

FIG. 7 is a block diagram showing an exemplary wireless communications system 700 in which an aspect of the disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include IC devices 725A, 725C, and 725B that include the disclosed memory footprint reduction of the compressed memory subsystem. It will be recognized that other devices may also include the disclosed memory footprint reduction of the compressed memory subsystem, such as the base stations, switching devices, and network equipment. FIG. 7 shows forward link signals 780 from the base stations 740 to the remote units 720, 730, and 750, and reverse link signals 790 from the remote units 720, 730, and 750 to base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communications systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to aspects of the present disclosure, the disclosure is not limited to these exemplary illustrated units. Aspects of the present disclosure may be suitably employed in many devices, which include the disclosed memory footprint reduction.

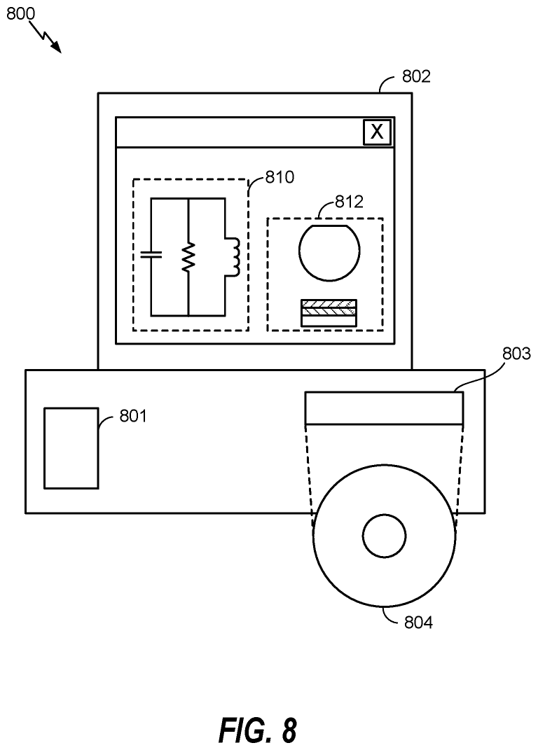

FIG. 8 is a block diagram illustrating a design workstation used for circuit, layout, and logic design of a semiconductor component, such as the of the compressed memory subsystem of the memory footprint reduction technique disclosed above. A design workstation 800 includes a hard disk 801 containing operating system software, support files, and design software such as Cadence or OrCAD. The design workstation 800 also includes a display 802 to facilitate design of a circuit 810 or an integrated circuit (IC) component 812 such as the disclosed of the compressed memory subsystem of the memory footprint reduction technique. A storage medium 804 is provided for tangibly storing the design of the circuit 810 or the IC component 812 (e.g., the memory of the memory footprint reduction). The design of the circuit 810 or the IC component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the IC component 812 by decreasing the number of processes for designing semiconductor wafers.

Implementation examples are described in the following numbered clauses:

1. A method for reducing a memory footprint of data stored in a compressed memory subsystem, the method comprising:
selecting a read/write data to store in the compressed memory subsystem;
searching a first compressed data storage pool of the compressed memory subsystem corresponding to a compressed size of the read/write data to identify a first free data block; and
storing the read/write data in a second free data block from a second compressed data storage pool of the compressed memory subsystem corresponding to a compressed size of the read/write data if the first compressed data storage pool is exhausted.

2. The method of clause 1, further comprising the storing compressed read/write data in the first free data block from the first compressed data storage pool of the compressed memory subsystem if the first compressed data storage pool is not exhausted.

3. The method of any of clauses 1 or 2, in which the second compressed data storage pool of the compressed memory subsystem comprises a next available larger data storage pool of the compressed memory subsystem.

4. The method of any of clauses 1-3, in which the second compressed data storage pool of the compressed memory subsystem comprises a largest compressed data storage pool of the compressed memory subsystem.

5. The method of any of clauses 1-4, further comprising generating meta data to identify a location of the read/write data within the compressed memory subsystem.

6. The method of clause 5, in which the meta data comprises a block index field and a block type field.

7. The method of clause 5, further comprising encoding up-binning in the meta data.

8. The method of any of clauses 1-7, in which storing the read/write data further comprises:
detecting a free data block from the first compressed data storage pool of the compressed memory subsystem; and
moving the read/write data from the second free data block of the second compressed data storage pool to the free data block in the first compressed data storage pool of the compressed memory subsystem.

9. The method of any of clauses 1-8, further comprising:
marking a cache line as dirty in a level two (L2) cache when the cache line is in a borrowed block; and
setting the cache line in memory to zeros to expedite return of the borrowed block.

10. The method of any of clauses 1-9, further comprising issuing a hardware interrupt when a free data block is unavailable in each data storage pool of the compressed memory subsystem.

11. A non-transitory computer-readable medium having program code recorded thereon for reducing a memory footprint of data stored in a compressed memory subsystem, the program code being executed by a processor and comprising:
program code to select a read/write data to store in the compressed memory subsystem;
program code to search a first compressed data storage pool of the compressed memory subsystem corresponding to a compressed size of the read/write data to identify a first free data block; and
program code to store the read/write data in a second free data block from a second compressed data storage pool of the compressed memory subsystem corresponding to an uncompressed size of the read/write data if the first compressed data storage pool is exhausted.

12. The non-transitory computer-readable medium of clause 11, further comprising program code to store the compressed read/write data in the first free data block from the first compressed data storage pool of the compressed memory subsystem if the first compressed data storage pool is not exhausted.

13. The non-transitory computer-readable medium of any of clauses 11 or 12, in which the second compressed data storage pool of the compressed memory subsystem comprises a next available larger data storage pool of the compressed memory subsystem.

14. The non-transitory computer-readable medium of any of clauses 11-13, in which the second compressed data storage pool of the compressed memory subsystem comprises a largest compressed data storage pool of the compressed memory subsystem.

15. The non-transitory computer-readable medium of any of clauses 11-14, further comprising program code to generate meta data to identify a location of the read/write data within the compressed memory subsystem.

16. The non-transitory computer-readable medium of clause 15, in which the meta data comprises a block index field and a block type field.

17. The non-transitory computer-readable medium of clause 15, further comprising program code to encode up-binning in the meta data.

18. The non-transitory computer-readable medium of any of clauses 11-17, in which the program code to store the read/write data further comprises:
program code to detect a free data block from the first compressed data storage pool of the compressed memory subsystem; and
program code to move the read/write data from the second free data block of the second compressed data storage pool to the free data block in the first compressed data storage pool of the compressed memory subsystem.

19. The non-transitory computer-readable medium of any of clauses 11-18, further comprising:
program code to mark a cache line as dirty in a level two (L2) cache when the cache line is in a borrowed block; and
program code to set the cache line in memory to zeros to expedite return of the borrowed block.

20. The non-transitory computer-readable medium of any of clauses 11-19, further comprising program code to issue a hardware interrupt when a free data block is unavailable in each data storage pool of the compressed memory subsystem.

For a firmware and/or software implementation, the methodologies may be implemented with modules (e.g., procedures, functions, etc.) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a non-transitory computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer. Disk and disc, as used herein, include compact disc (CD), laser disc, optical disc, digital versatile disc (DVD), floppy disk and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, various changes, substitutions, and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above, and below may refer to sides of a substrate or electronic device. Moreover, the scope of the present application is not intended to be limited to the configurations of the process, machine, manufacture, composition of matter, means, methods, and steps described in the specification. As one of ordinary skill in the art will readily appreciate from the disclosure, processes, machines, manufacture, compositions of matter, means, methods, or steps, presently existing or later to be developed that perform the same function or achieve the same result as the corresponding configurations described herein may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the disclosure may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for reducing a memory footprint of data stored in a compressed memory subsystem, the method comprising:
selecting a read/write data to store in the compressed memory subsystem;
searching a first compressed data storage pool of the compressed memory subsystem corresponding to a compressed size of the read/write data to identify a first free data block; and
storing the read/write data in a second free data block from a second compressed data storage pool of the compressed memory subsystem corresponding to a compressed size of the read/write data if the first compressed data storage pool is exhausted.

2. The method of claim 1, further comprising the storing compressed read/write data in the first free data block from the first compressed data storage pool of the compressed memory subsystem if the first compressed data storage pool is not exhausted.

3. The method of claim 1, in which the second compressed data storage pool of the compressed memory subsystem comprises a next available larger data storage pool of the compressed memory subsystem.

4. The method of claim 1, in which the second compressed data storage pool of the compressed memory subsystem comprises a largest compressed data storage pool of the compressed memory subsystem.

5. The method of claim 1, further comprising generating meta data to identify a location of the read/write data within the compressed memory subsystem.

6. The method of claim 5, in which the meta data comprises a block index field and a block type field.

7. The method of claim 5, further comprising encoding up-binning in the meta data.

8. The method of claim 1, in which storing the read/write data further comprises:
detecting a free data block from the first compressed data storage pool of the compressed memory subsystem; and
moving the read/write data from the second free data block of the second compressed data storage pool to the free data block in the first compressed data storage pool of the compressed memory subsystem.

9. The method of claim 1, further comprising:
marking a cache line as dirty in a level two (L2) cache when the cache line is in a borrowed block; and
setting the cache line in memory to zeros to expedite return of the borrowed block.

10. The method of claim 1, further comprising issuing a hardware interrupt when a free data block is unavailable in each data storage pool of the compressed memory subsystem.

11. A non-transitory computer-readable medium having program code recorded thereon for reducing a memory footprint of data stored in a compressed memory subsystem, the program code being executed by a processor and comprising:
program code to select a read/write data to store in the compressed memory subsystem;
program code to search a first compressed data storage pool of the compressed memory subsystem corresponding to a compressed size of the read/write data to identify a first free data block; and
program code to store the read/write data in a second free data block from a second compressed data storage pool of the compressed memory subsystem corresponding to a compressed size of the read/write data if the first compressed data storage pool is exhausted.

12. The non-transitory computer-readable medium of claim 11, further comprising program code to store the compressed read/write data in the first free data block from the first compressed data storage pool of the compressed memory subsystem if the first compressed data storage pool is not exhausted.

13. The non-transitory computer-readable medium of claim 11, in which the second compressed data storage pool of the compressed memory subsystem comprises a next available larger data storage pool of the compressed memory subsystem.

14. The non-transitory computer-readable medium of claim 11, in which the second compressed data storage pool of the compressed memory subsystem comprises a largest compressed data storage pool of the compressed memory subsystem.

15. The non-transitory computer-readable medium of claim 11, further comprising program code to generate meta data to identify a location of the read/write data within the compressed memory subsystem.

16. The non-transitory computer-readable medium of claim 15, in which the meta data comprises a block index field and a block type field.

17. The non-transitory computer-readable medium of claim 15, further comprising program code to encode up-binning in the meta data.

18. The non-transitory computer-readable medium of claim 11, in which the program code to store the read/write data further comprises:
program code to detect a free data block from the first compressed data storage pool of the compressed memory subsystem; and
program code to move the read/write data from the second free data block of the second compressed data storage pool to the free data block in the first compressed data storage pool of the compressed memory subsystem.

19. The non-transitory computer-readable medium of claim 11, further comprising:
program code to mark a cache line as dirty in a level two (L2) cache when the cache line is in a borrowed block; and
program code to set the cache line in memory to zeros to expedite return of the borrowed block.

20. The non-transitory computer-readable medium of claim 11, further comprising program code to issue a hardware interrupt when a free data block is unavailable in each data storage pool of the compressed memory subsystem.
